(19) United States
(12) Patent Application Publication
(10) Pub. No.: US 2006/0184608 A1
(43) Pub. Date: Aug. 17, 2006

(54) Method and system for contextual site rating

(75) Inventors: Peter G. Williams, Tadley (GB); Mark A. Wilson-Thomas, Tadley (GB); Martin Peck, Twyford (GB); Robert J. Wilcox, Twyford (GB); Andrew Burns, Claverley (GB); Martin Grayson, Elston (GB)

Correspondence Address: SHOOK, HARDY & BACON L.L.P.;(c/o MICROSOFT CORPORATION), 2555 GRAND BOULEVARD, KANSAS CITY, MO, 64108-2613, US

(73) Assignee: Microsoft Corporation, Redmond, WA (US)

(21) Appl. No.: 11/056,731

(22) Filed: Feb. 11, 2005

(51) Int. Cl. G06F 15/16

(52) U.S. Cl. 709/203

(57) ABSTRACT

The present invention allows a user or community of users to rate content across a variety of web sites and display contextual sensitive reviews. Rather than the rating information being controlled by the web site owner, the rating information may be owned and controlled by a third party. Users have the ability to rate a web site, review ratings from a web site, or operate a web site rating system.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

This invention relates to the field of computer software using web browsers, toolbars, and data storage.

### BACKGROUND OF THE INVENTION

Some web sites currently have a rating system that allows users to rate the web site in one way or another. Their implementation varies from web site to web site, and forms a web site centric view. That means the ratings are held within the web site and a user has to visit the web site in order to access the ratings information. The web site owner has control over the ratings information including how this information is stored, how this information is exposed, and who gets access to the information.

Typically, users are not aware if a web site has a rating system or how the rating system is implemented. They usually have to got to the web site to learn that the web site can be rated or surveyed. Usually, web site owners implement their own rating system in order to tabulate or collect data on the user's experience when visiting the web site. Unfortunately, the web site owner may manipulate this data if the feedback that is received from users is unfavorable. Such an example may be seen when searching for an apartment. There are numerous web sites providing details about a particular apartment when a person is apartment hunting. The information is very useful when the person resides some distance from the potential apartment location but needs information to make decisions about which apartments to pursue further. Unfortunately, many of these web sites are run by the apartment owners who maintain their own web site or are run by agencies who have been paid an advertising fee by the apartment owners to carry information about their apartments. There is a big potential to skew information towards the favorable spectrum for the apartment owners when surveys are provided. The present invention provides an alternative to the current state of the art by removing control of the rating information from web site owners or agencies with biases to a third party, and providing the individual user with a rating tool, and direct control, at their computer without going to a particular web site.

### BRIEF SUMMARY OF THE INVENTION

The present invention allows a consistent experience across all web sites by extending a web browser to be part of a rating system. The ratings information for the web sites are stored in a central location under the control of the rating agency or other third party, rather than under the control of the web site owner or manager. This disclosure describes, among other things, methods and a system for contextual site rating.

A method for rating a web site is provided that includes operating a web browser and a toolbar at a computing device with the toolbar containing at least a button. The button is selected to rate a uniform resource locator (URL) or web site displayed in the web browser without the user leaving the URL or web site. With the same button selected, rated information of the URL or web site is stored in a data store.

A method is also provided for reviewing a web site rating. The method includes operating a web browser and a toolbar at a computing device with the toolbar containing a button. The button is selected to retrieve information from a data store about a URL or web site displayed in the web browser without the user leaving the URL or web site. Information about the URL or web site is displayed to the user.

A system for operating a rating system is also provided. The system includes at least one computer operable to execute a web browser and a toolbar. The system further includes at least one data store operable to store rating information. The system further includes a communication channel operable to link the computer and the data store. The system further provides a first button selectable to rate the URL or web site displayed in the web browser, and to store the rate information in the data store. A second button is selectable to retrieve information from the data store about the URL or web site displayed in the web browser. The system also provides a display device connected to the computer to display information about the URL or web site retrieved from the data store.

### BRIEF DESCRIPTION OF THE SEVERAL VIEWS OF THE DRAWINGS

The present invention is described in detail below with reference to the attached drawing figures, which are incorporated herein by reference, and wherein:

FIG. 1 is a block diagram of a computing system suitable for use with the present invention;

FIG. 2 is a flowchart illustrating an exemplary process for operating an embodiment of the present invention;

FIG. 3 is a block diagram of an exemplary operating environment illustrating an embodiment of the present invention;

FIG. 4 is a block diagram of an exemplary operating environment illustrating an embodiment of the present invention;

FIG. 5 is a diagram of an exemplary web page illustrating an embodiment of the present invention;

FIG. 6 is a flowchart illustrating an exemplary process for operating an embodiment of the present invention; and

FIG. 7 is a flowchart illustrating an exemplary process for operating an embodiment of the present invention.

### DETAILED DESCRIPTION OF THE INVENTION

The present invention will be better understood from the detailed description provided below and from the accompanying drawings of various embodiments of the invention, which describe, for example, methods that allow users to rate web sites, and obtain previously entered rating information about a web site. The detailed description and drawings, however, should not be read to limit the invention to the specific embodiments. Rather, these specifics are provided for explanatory purposes that help the invention to be better understood.

Contextual Site Rating is a tool that provides users an ability to rate URLs or web sites without leaving the current web page they are viewing. Computer software is implemented and integrated into the user's browser to provide the experience of having a rating system available to the user at most times. The user may provide ratings as well as retrieve rating reviews for the currently viewed URL or web site.

Having briefly described an overview of the present invention, an exemplary operating environment for the present invention is described below.

Exemplary Operating Environment

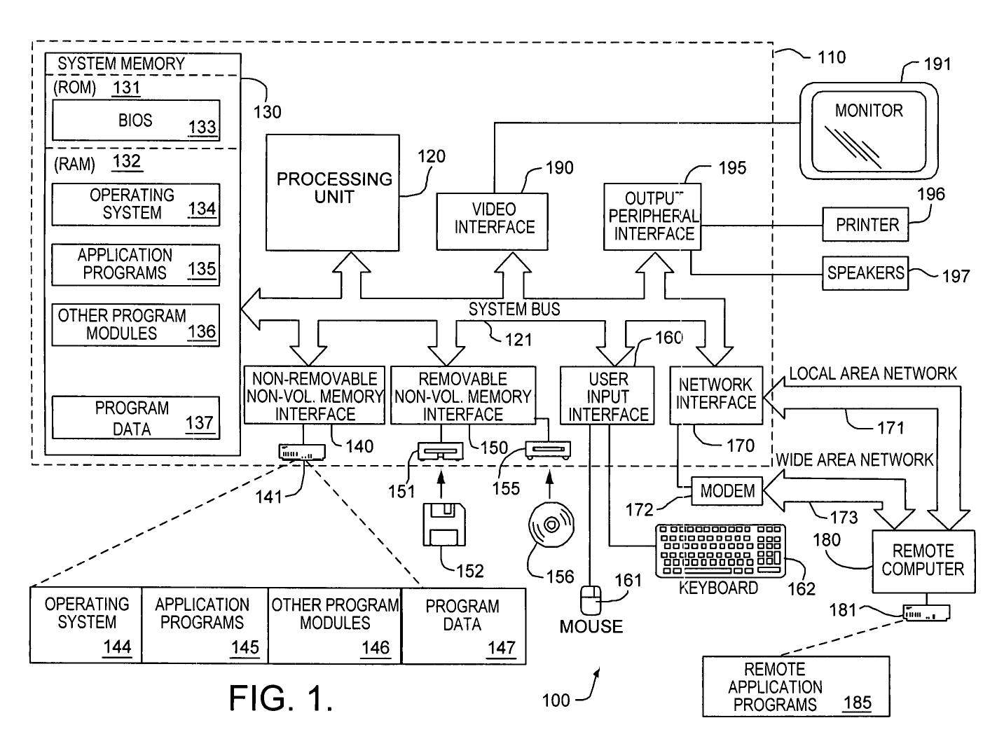

Referring to the drawings in general and initially to FIG. 1 in particular, wherein like reference numerals identify like components in the various figures, an exemplary operating environment for implementing the present invention is shown and designated generally as computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks (DVDs), digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other programs 146 and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the network interface 170, or other appropriate mechanism. In a networked environment, program modules depicted relative to the computer 110, or portions thereof, may be stored in a remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131, instructs the processing unit 120 to load the operating system, or necessary portion thereof, from the hard disk drive 141 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between the various steps herein disclosed unless and except when the order of individual steps is explicitly described.

Contextual Site Rating

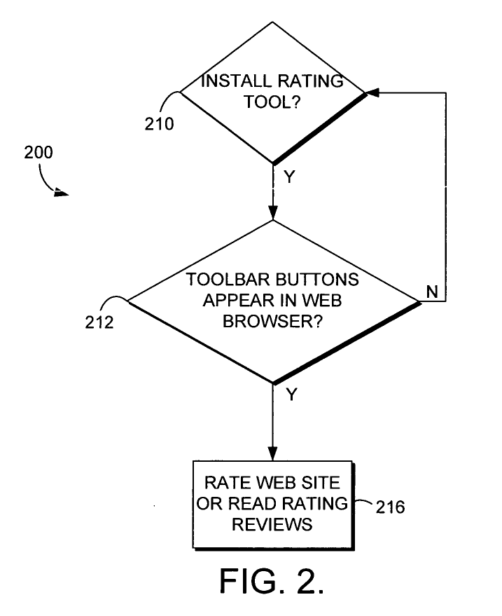

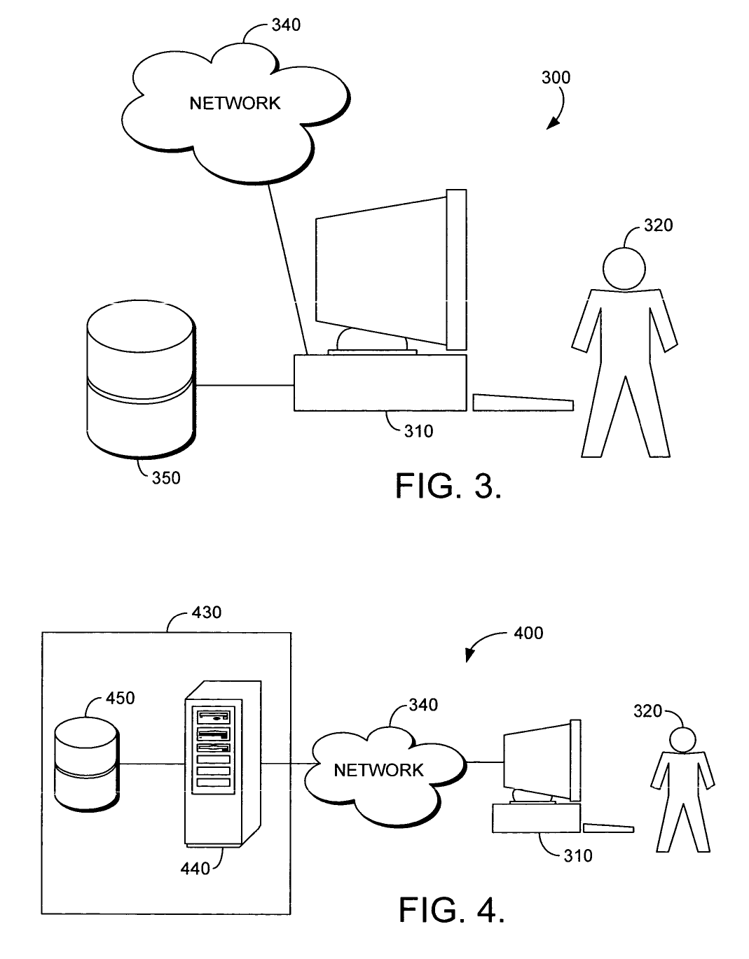

In FIG. 2, an exemplary overall process for the site rating operation is shown in rating tool 200. Rating tool 200 illustrates the high-level steps taken to utilize tool 200. As will be discussed later, a user operates the tool from a computing device (shown as 310 in FIG. 3) using a web browser and other devices. The user operates the tool by first downloading the relevant computer software or installing the relevant software as shown in a step 210. The computer software may come from one or more vendors and may be accessed in a number of ways, either through a downloading of the software over the internet or by loading the software directly on the user's computing device 310. Rating tool 200 may also be an accessible software plug-in which may be obtained by accessing another computing device or web site.

In a step 212, the user or system determines if the toolbar associated with rating tool 200 has been installed, along with the corresponding buttons for rating tool 200. If the correct buttons appear on the toolbar, the software or plug-in has installed or loaded correctly. One may note that the toolbar may contain a number of buttons relating to various unrelated software programs. The toolbar provides the user quick access to the functionality of the rating tool 200, as further described below. However, the functionality of the rating tool 200 could be provided to the user in other locations or as a different display, such as on the taskbar. The taskbar is a visual representation of icons found at the bottom of the viewing screen in computing devices. Returning to step 212, if the toolbar does not contain the correct buttons in the web browser, the user may install rating tool 200 again or may be prompted by the system to do so.

In a step 216, the user operates rating tool 200 to rate web sites or read reviews or web sites posted by other users. In this step, the user selects the appropriate one of two buttons for rating tool 200. Either the user may rate the current URL or web site that is being shown to the user, or the user may read rating reviews for the current URL or web site.

The illustration in FIG. 2 is merely exemplary to show one embodiment of the present invention. The execution of the steps may change depending on the circumstances. For example, step 212 may be encountered before step 210.

Now referring to FIG. 3, a rating system 300 is shown with a computing device 310, a user 320, a network 340, and a data store 350. User 320 interacts with computing device 310 to operate rating tool 200 discussed in FIG. 2. Computing device 310 provides the interface for user 320 to perform the rating and review of URLs and web sites.

Computing device 310 is connected to network 340 in order to provide user 320 with an internet experience. User 320 can access URLs and web sites through the connection to network 340. The use of the internet has become commonplace and the types of connections between computing device 310 and network 340 vary greatly and will not be discussed here. Likewise, user 320 may have many choices in determining which URLs or web sites to visit. However, user 320 may access URLs and web sites through the use of a web browser operating in computing device 310.

One may note that although the current illustration shows computing device 310 as a computer, computing device 310 may be a server, a personal digital assistant (PDA), a wireless phone with web access capability, or a paging device. In fact, computing device 310 may include any device that has the capability of accessing web pages and that has some type of display.

In FIG. 3, computing device 310 is also connected to data store 350. Data store 350 functions as a storage medium for data and computer software. More particularly, data store 350 functions as a repository for ratings information. As ratings are created for users, including user 320, that information is stored in data store 350. When users want to read a rating for the web site they are currently viewing, that information is also retrieved from data store 350.

Data store 350 may exist in the form of many devices including, but not limited to, disk drives, computer storage medium, and memory as discussed FIG. 1. Data store 350 may reside collocated to computing device 310 or may be located remotely. Although one embodiment of the present invention is shown in FIG. 3, additional computing devices may be in communication with data store 350.

Now referring to FIG. 4, another illustration is provided showing a rating system 400. In this illustration, rating system 400 contains computing device 310, user 320, network 340, a rating agency 430, a server 440, and a data store 450. FIG. 4 is exemplary of rating system 400 implemented with a third party administering and managing rating system 400. In FIG. 3, rating system 300 is self-contained within a localized area, namely computing device 310, data store 350, and network 340. One may conclude that the control of rating information in FIG. 3 rests with the owner of the web site. However, in FIG. 4, the web site, with ownership by person A and accessed through network 340 at computing device 310, may be different from the ratings activity performed by person B and identified in the illustration at rating agency 430. The embodiment of the present invention illustrates the independence that rating agency 430 may have over the owner or manager of the web site. As a benefit to the invention, ratings information may be created and collected without user 320 worrying about biases in the rating information or manipulation from the web site owner, although no assurances may be made about the content of ratings when created and stored in data store 450.

FIG. 4 illustrates that the user experience at computing device 310 with user 320 may be separated from the rating agency 430. Server 440 may be used to manage one or more connections to other computing devices or other network connections. If rating agency 430 manages the task of collecting and maintaining various ratings of web sites, server 440 may operate to manage network flow of information as well manage access to data store 450. Data store 450 functions in the same capacity as data store 350 discussed in FIG. 3.

One may note that the illustration of FIG. 4 is merely exemplary and that more devices may be included and configured to implement other embodiments of the present invention. For example, there may be more than one rating agency 430 as well as more than one data store 450 connected to server 440. In addition, there may be many computing devices such as computing device 310 connected to network 340 accessing rating agency 430 to either create ratings or retrieve ratings to review information.

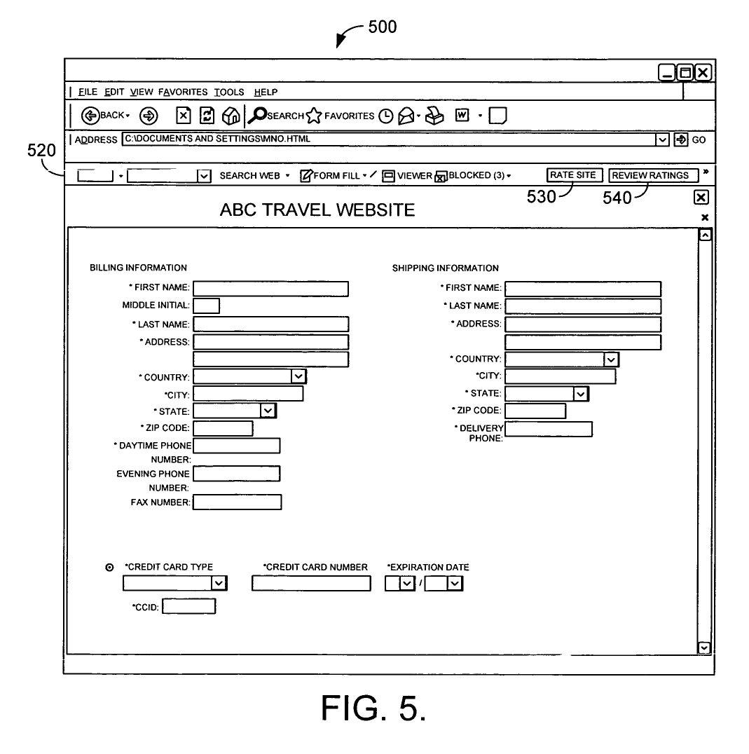

In FIG. 5, a diagram of an exemplary web page illustrating an embodiment of the present invention is shown in web page 500. The actual web page may differ when implemented among different users. However, web page 500 is exemplary of what user 320 might see when operating rating tool 200. In this illustration, a travel web site is shown. The browser has the rating tool 200 installed and the browser thus has a toolbar 520 with rating tool 200 identified by a first button 530 and a second button 540. If user 320 wants to rate the web site or the URL, user 320 selects first button 530 to create and submit a rating form. Although discussed earlier, the completed rating form is stored in data store 350 or data store 450. The rating of the web site occurs independently of any controls established by the web site owner. In fact, the web site owner may not know that his or her web site has been rated or that rating information is being kept about the web site.

If user 320 desires to obtain or review rating information for a particular URL or web site that is currently being viewed, user 320 selects second button 540. Rating tool 200 obtains the relevant information. As mentioned earlier, the web site owner may riot be aware that rating information is being retrieved and viewed by user 320 because the control of rating information is performed by rating agency 430. The present invention may be implemented in such a way where the web site owner has no control over, or access to, rating information, shown in FIG. 4.

One may appreciate that embodiments of the present invention allow for rating information to be created, collected, and reviewed without changing from the currently viewed web page. The present invention may allow flexibility in giving the user the ability to rate almost all web sites.

As was discussed earlier, first button 530 and second button 540 may be implemented in locations other than toolbar 520. Other embodiments may have first button 530 and second button 540 located on the desktop of computing device 310 or may have them located on the taskbar. In addition, the present invention may be implemented with the use of one button to perform the function of creating, collecting, submitting, and reviewing ratings information.

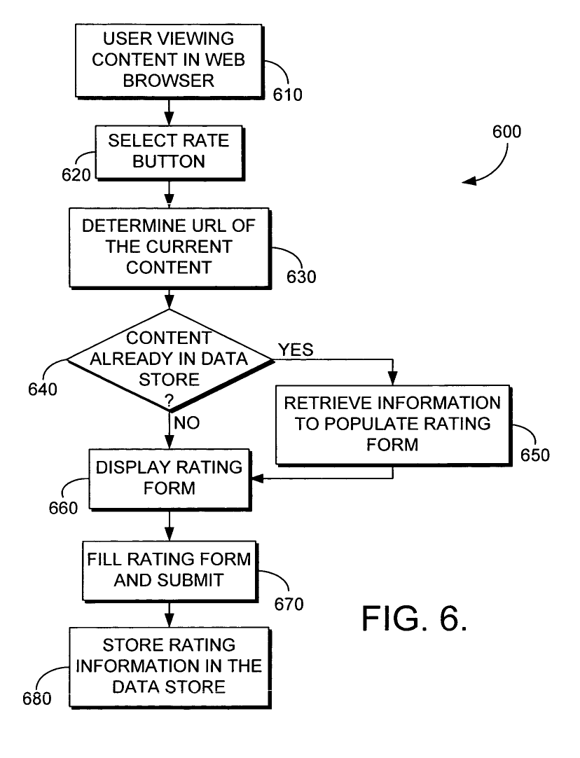

In FIG. 6, a flowchart illustrating an exemplary process is shown in 600. In a step 610, user 320 begins the process by viewing content in the web browser. Step 610 signifies the ordinary web surfing activities that occur during an internet experience. An assumption has been made in FIG. 6 that the process according to FIG. 2 has been implemented. In fact, the method described in FIG. 6 may be viewed as an expansion of step 216 discussed in FIG. 2.

While user 320 is viewing content in the web browser, user 320 may decide to rate the web site by selecting a rate button in step 620. Computer software for rating tool 200 executes after the rate button has been selected to determine the URL of the currently viewed web page, step 630. The computer software continues to execute to determine if rating information has already been stored in data store 350 or data store 450 identified by step 640. If rating information exists, some of the rating information is retrieved from data store 350 or data store 450 and populated into a rating form, step 650, that is displayed on user 320's screen at computing device 310, step 660. Alternatively, if no rating information exists as determined by step 640, a blank rating form is displayed to user 320, again identified by step 660. User 320 may fill in rating information into the form and submit the rating information in step 670. The rating information is then stored in step 680 in data store 350 or data store 450.

Although many of the steps identified in FIG. 6 are dependent upon one another, the steps may be performed in another sequence than the one described above. The current illustration and discussion is merely exemplary and does not signify a hard-coded process to be followed. For example, step 660 may be implemented in another embodiment of the present invention to occur after step 620. Also, step 630 may be executed after step 660 to determine the URL after displaying a rating form.

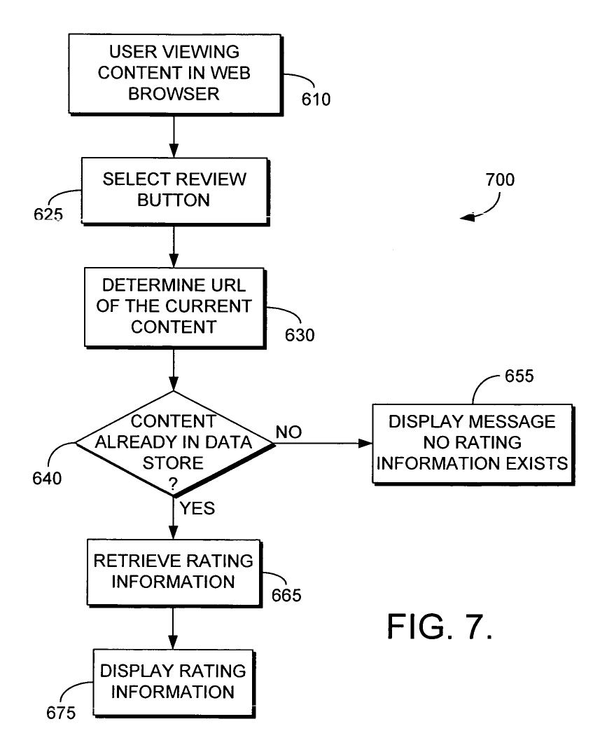

With regards to FIG. 7, another flowchart illustrating an exemplary process is shown in 700. The process identified by FIG. 6 and FIG. 7 are quite similar with differences being that the process in FIG. 7 illustrates how rating information is retrieved and reviewed, and the process in FIG. 6 illustrates how rating information is created, collected, and stored.

In step 610, the same process identified in FIG. 6 is performed. In a step 625, user 320 selects a button to review rating information that may have been stored in data store 350 or data store 450 earlier. As was discussed in FIG. 6, computer software executes to determine the URL of the content shown on the web page and determines if rating information has already been created and stored for the particular URL or web site, step 630 and step 640. If no rating information can be found for the URL or web site, an embodiment of the present invention may display a message stating that no rating information exists as identified by a step 655. One may appreciate that another embodiment may be implemented to provide a different scheme or no scheme at all if no rating information is found. If rating information exists, computer software, executing as part of the implementation of rating tool 200, retrieves rating information in a step 665 and displays the rating information in a step 675.

Again, the steps identified in FIG. 7 may be executed without regard to order. Some of the steps are coupled together but this is merely exemplary to illustrate the embodiment of the present invention. For example, user 320 has to begin the process by viewing the web page with a web browser in step 610 before the review button in step 625 may be selected. However, step 665 may be executed after step 625 to retrieve rating information. Furthermore, step 640 is not mandatory. The present invention may be implemented without determining if rating information is already stored in data store 350 or data store 450. If step 640 is removed, step 650 in FIG. 6 and step 655 in FIG. 7 may be removed also, but the present invention can work, albeit in another embodiment.

One skilled in the art will appreciate that methods and systems in accordance with the present invention may be implemented using computer software. Such software may take the form of computer-readable code embodied on one or more computer-readable media. Software implementing the present invention may operate independently, but may also be incorporated with other software or vendor programs. Various software languages may be used to implement methods and systems in accordance with the present invention.

The invention claimed is:

1. A computer-implemented method for rating a web site comprising:
at a computing device, providing a web browser with at least one selection button usable to rate a displayed web site or URL;
monitoring the browser for selection of the button to rate at least one of a URL and a web site displayed in the web browser;
without leaving the at least URL and web site, receiving rating information; and
storing the rating information of the at least URL and web site in a data store.

2. The method of claim 1, wherein the selection button is provided on the toolbar of the browser.

3. The method of claim 1, further comprising determining the URL of the web page.

4. The method of claim 3, further comprising providing a rating form to rate the at least URL and web site.

5. The method of claim 4, further comprising determining if rating information is already stored for the at least URL and web site, and if stored, retrieving rating information from the data store to pre-populate a portion of the provided rating form.

6. The method of claim 5, wherein storing the rating information of the at least URL and web site in the data store comprises sending the rating information by the web browser to the data store.

7. The method of claim 6, wherein the storing is achieved by transmitting the rating information to the data store in a central location under the control of an entity or person other than the owner or manager of the at least URL and web site.

8. A computer readable medium having instructions stored thereon for performing the method of claim 1.

9. A computer-implemented method for reviewing a web site rating comprising:
at a computing device, providing a web browser with at least one selection button usable to rate a displayed web site or URL;
monitoring the browser for selection of the button to retrieve information from a data store about at least one of a URL and a web site displayed in the web browser without leaving the at least URL and web site;
providing retrieved information from the data store; and
displaying the information of the at least URL and web site.

10. The method of claim 9, further comprising determining the URL from the content shown on the web page.

11. The method of claim 10, wherein information comprises rating information.

12. The method of claim 11, further comprising determining if rating information is available in the data store, and if not available, displaying at least a message that no rating information exists.

13. A computer readable medium having instructions stored thereon for performing the method of claim 9.

14. A computer-implemented system for operating a rating system comprising:
at least one computer operable to execute a web browser and a toolbar;
at least one data store operable to store rating information;
a communication channel operable to link the at least computer and the at least data store;
the toolbar operable with at least a first button selectable to rate at least one of a URL and a web site displayed in the web browser, and to store the rated information in the at least data store;
the toolbar operable with at least a second button selectable to retrieve information from the at least data store about the at least URL and web site displayed in the web browser; and
a display device connected to the at least computer to display information about the at least URL and web site retrieved from the at least data store.

15. The system of claim 14, wherein the first button and second button are the same.
